(19) United States
(12) Patent Application Publication
(10) Pub. No.: US 2012/0030462 A1
(43) Pub. Date: Feb. 2, 2012

(54) SYSTEM AND DEVICE FOR ENCRYPTING AND DECRYPTING ELECTRONIC FILES AND METHOD THEREOF

(75) Inventor: WEN SHU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/915,048

(22) Filed: Oct. 29, 2010

(30) Foreign Application Priority Data
Jul. 29, 2010 (CN) 201010237989.X

(51) Int. Cl. H04L 9/00

(52) U.S. Cl. 713/162; 713/150

(57) ABSTRACT

A method for encrypting electronic files includes: receiving a request signal consisting of an IP address of a receiver and information about a desired electronic file; obtaining a function and the desired electronic file from a storage unit, and starting to time; obtaining a timing length when the electronic file has been obtained completely; substituting the timing length into the function to obtain an encryption key via an encryption module; and encrypting the electronic file using the encryption key.

### BACKGROUND

1. Technical Field

The present disclosure relates to devices for transmitting electronic files and, particularly, to a device for encrypting electronic files before transmitting the electronic files.

2. Description of Related Art

During transmission of electronic files on the Internet, the electronic files are generally encrypted using an encryption key. However, the encryption key is usually constant, and consequently, relatively easily cracked.

Therefore, it is desirable to provide a device for encrypting data by using a dynamic secret key to overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a system for encrypting and decrypting electronic files in accordance with an exemplary embodiment.

FIG. 2 is a block diagram of a transmitter of the system of FIG. 1 in accordance with an exemplary embodiment.

FIG. 3 is a block diagram of a receiver of the system of FIG. 1 in accordance with an exemplary embodiment.

FIG. 4 is a flowchart illustrating a method for encrypting electronic files in accordance with an exemplary embodiment.

FIG. 5 is a flowchart illustrating a method for decrypting electronic files in accordance with an exemplary embodiment.

### DETAILED DESCRIPTION

Embodiments of the present disclosure will now be described in detail below, with reference to the accompanying drawings.

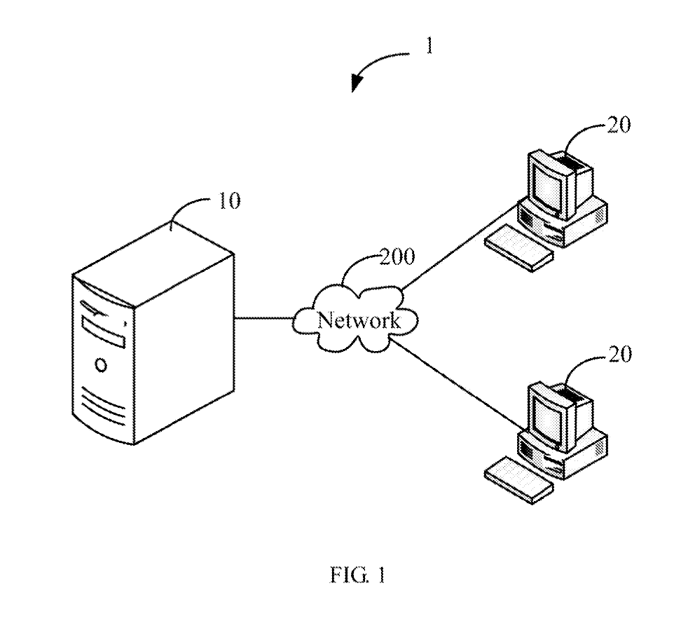

Referring to FIG. 1, a system 1 capable of encrypting electronic file using a dynamic encryption key is provided. The system 1 includes a transmitter 10 and at least one receiver 20. The transmitter 10 communicates with the at least one receiver 20 via a network 200. The transmitter 10 can be a personal computer, a server computer or other device, and the receiver 20 can be a personal computer, a mobile phone or other device. The network 200 can be the Internet, a local area network, or other appropriate networks. The transmitter 10 encrypts electronic files before transmitting the electronic files to the receiver 20, and the receiver 20 decrypts the received data to obtain the original electronic files. In an embodiment, the electronic files can be pictures, audios, videos, or a combination of the pictures, audios, and videos.

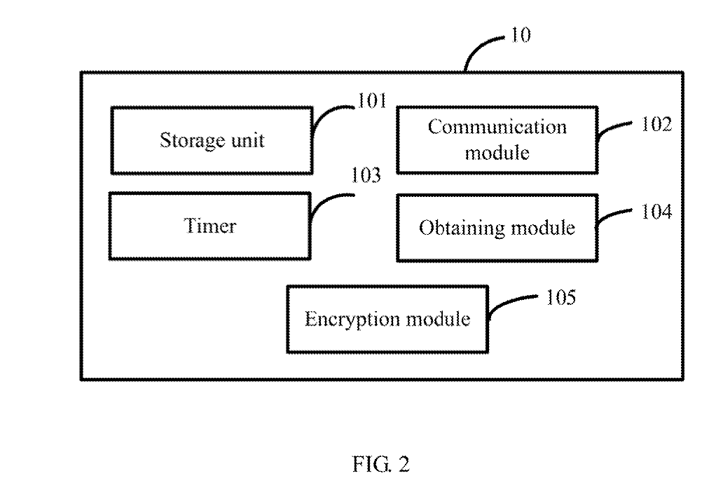

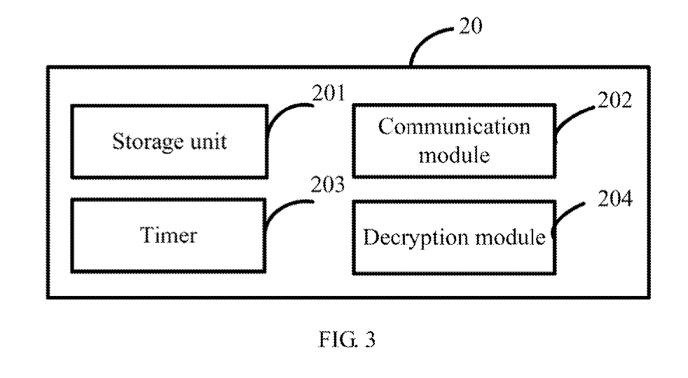

Referring to FIGS. 2 and 3, the transmitter 10 includes a storage unit 101, a communication module 102, a timer 103, an obtaining module 104, and an encryption module 105.

The storage unit 101 stores the electronic files and a function f(x). The function f(x) can be any suitable mathematical function, such as f(x)=2x.

The receiver 20 includes a storage unit 201, a communication module 202, a timer 203, and a decryption module 204. The storage unit 201 stores the same function f(x) of the storage unit 101. The receiver 20 communicates with the transmitter 10 via the communication module 202 and the communication module 102.

When the receiver 20 wants to obtain an electronic file from the transmitter 10, the receiver 20 transmits a request signal to the transmitter 10 via the communication module 202. The request signal includes an Internet protocol address (IP address) of the receiver 20 and information about a desired electronic file, the information can be a file name of the desired electronic file and other suitable information. The transmitter 10 receives the request signal via the communication module 102. The timer 203 of the receiver 20 starts to time when the communication module 202 of the receiver 20 transmits the request signal, and the timer 103 of the transmitter 10 starts to time when the communication module 102 of the transmitter 10 receives the request signal.

The obtaining module 104 of the transmitter 10 obtains the function f(x) and the desired electronic file from the storage unit 101 according to the request signal, when the communication module 102 receives the request signal.

The encryption module 105 obtains a timing length t1 from the timer 103 after the obtaining module 104 obtains the electronic file completely. The timing length t1 is a time duration during the obtaining module 104 starts to obtain the electronic file until the obtaining module 104 obtains the electronic file completely from the storage unit 101. The encryption module 105 substitutes the timing length t1 into the function f(x) to obtain a constant, and the constant is the encryption key. The encryption key is then used to encrypt the electronic file by the encryption module 105.

In the embodiment, after the obtaining module 104 obtains the electronic file completely, the communication module 102 of the transmitter 10 transmits a ready signal to the receiver 20. The decryption module 204 obtains a timing length t2 from the timer 203 when the communication module 201 of the receiver 20 receives the ready signal. The timing length t2 is a time duration during which the communication module 202 starts to transmit the request signal until the communication module 202 receives the ready signal. Because the speed of transmitting the request signal and the ready signal is very quick and the time spent transmitting the request signal and the ready signal is very short, the timing length t1 can be regarded as equal to the timing length t2.

The decryption module 204 obtains the function f(x) from the storage unit 201 and substitutes the timing length t2 into the function f(x), then obtains a decryption key. Because the timing length t2 is equal to the timing length t1, and the function f(x) stored in the storage unit 201 is the same as that stored in the storage unit 101, then the encryption key is the same as the decryption key. The decryption module 204 decrypts the electronic file received by the communication unit 202 using the decryption key and obtains the original electronic file.

In the embodiment, the timing lengths t1 and t2 are determined by the file size of the electronic file to be transmitted to the receiver 20, namely, if the file size of the electronic file is different, the time duration from the obtaining module 104 starts to obtain the electronic file until the electronic file has been obtained completely is also different. Therefore, in the embodiment, for different electronic file, the encryption key and decryption key are different, which increases the safety of transmitting electronic files via the network.

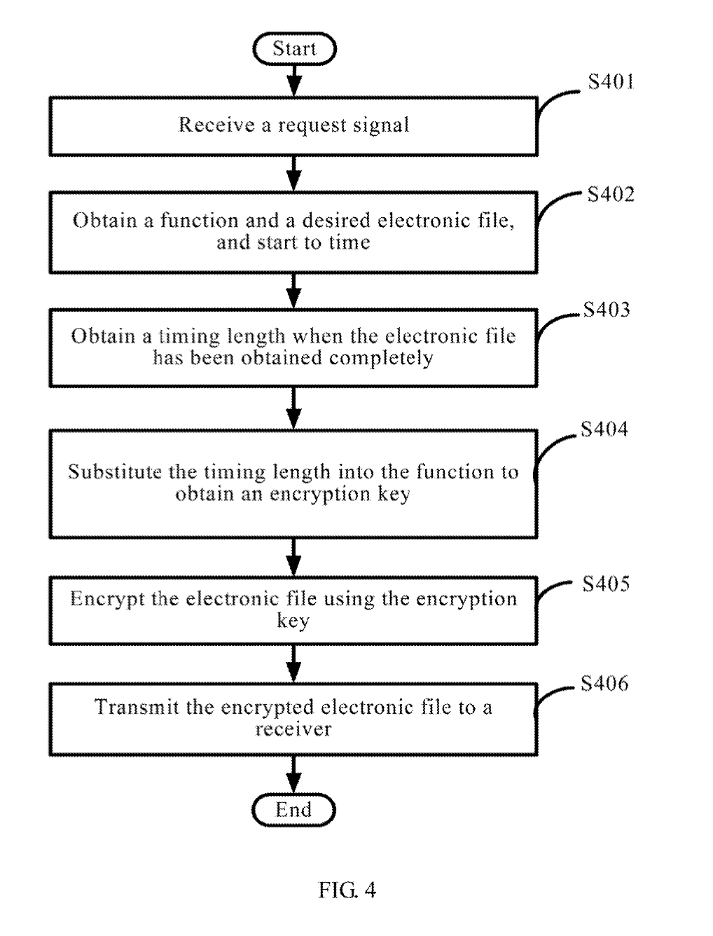

FIG. 4 is a flowchart illustrating an encryption method applied in the system 1. In step S401, the communication module 102 of the transmitter 10 receives a request signal; the request signal includes the IP address of the receiver 20 and information about a desired electronic file.

In step S402, the obtaining module 104 obtains a function f(x) from the storage unit and the desired electronic file according to the request signal, and the timer 103 starts to time when the communication module 102 receives the request signal.

In step S403, the encryption module 103 obtains the timing length t1 from the timer 103 when the obtaining module 104 has obtained the electronic file completely.

In step S404, the encryption module 103 substitutes the timing length t1 into the function f(x) to obtain the encryption key.

In step S405, the encryption module 103 encrypts the electronic file using the encryption key.

In step S406, the communication module 102 transmits the encrypted electronic file to the receiver 20 according to the IP address of the receiver 20.

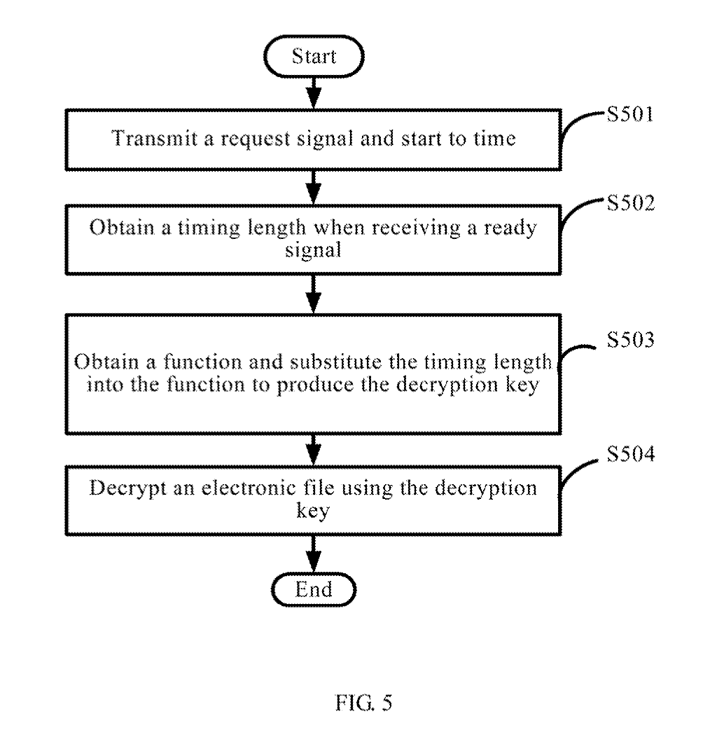

FIG. 5 is a flowchart illustrating a decryption method applied in the system 1. In step S501, the communication module 202 transmits a request signal to the transmitter 10, and the timer 203 starts to time.

In step S502, the decryption module 204 obtains the timing length t2 from the timer 203 when the communication module 202 receives a ready signal from the transmitter 10.

In step S503, the decryption module 204 obtains the function f(x) and substitutes the timing length t2 into the function f(x) to obtain the decryption key.

In step S504, the decryption module 204 decrypts the electronic file using the decryption key when the communication module 202 receives the electronic file.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A system for encrypting and decrypting electronic files, comprising:
a transmitter; and
a receiver;
wherein the transmitter comprises:
a first storage unit storing electronic files and a function;
a first communication module;
a first timer, configured to time when the first communication module receives a request signal from the receiver, wherein the request signal comprises an IP address of the receiver and information about a desired electronic file;
an obtaining module, configured to obtain the function and the desired electronic file from the first storage unit according to the request signal;
an encryption module, configured to obtain a first timing length from the first timer when the obtaining module obtains the electronic file completely, and substitute the first timing length into the function to obtain an encryption key, and further configured to encrypt the electronic file obtained by the obtaining module using the encryption key; and
the first communication module, further configured to transmit a ready signal to the receiver after the obtaining module has obtained the electronic file completely, and further configured to transmit the electronic file encrypted by the encryption module to the receiver; and
the receiver comprises:
a second storage unit, configured to store the same function as that stored in the first storage unit;
a second communication module, configured to transmit the request signal to the receiver and receive the ready signal and the encrypted electronic file from the transmitter;
a second timer, configured to time when the second communication module starts to transmit the request signal to the transmitter; and
a decryption module, configured to obtain a second timing length from the second timer when the second communication module receives the ready signal from the transmitter, and further configured to obtain the function from the second storage unit and substitute the second timing length into the function to obtain a decryption key, and further configured to decrypt the electronic file using the decryption key.

2. The system according to claim 1, wherein the first timing length is equal to the second timing length and the encryption key is the same as the decryption key.

3. The system according to claim 1, wherein the transmitter is a personal computer or a sever computer.

4. The system according to claim 1, wherein the receiver is a personal computer.

5. A device for encrypting electronic files, comprising:
a communication module;
a storage unit storing a function;
a timer, configured to time when the communication module receives a request signal comprising an IP address of a receiver and information about a desired electronic file;
an obtaining module, configured to obtain the function, and the electronic file from the storage unit; and
an encryption module, configured to obtain a timing length from the timer when the obtaining module obtains the electronic file completely, and substitute the timing length into the function to obtain an encryption key, and further configured to encrypt the electronic file obtained by the obtaining module using the encryption key, the encrypted electronic file being transmitted to the receiver via the communication module according to the IP address of the receiver.

6. The device according to claim 5, wherein the timing length is a time duration during the obtaining module starts to obtain the electronic file until the obtaining module obtains the electronic file completely.

7. A device for decrypting electronic files, comprising:
a storage unit storing a function;
a communication module, configured to receive an electronic file from a transmitter;
a timer, configured to time when the communication module starts to transmit a request signal to the transmitter; and
a decryption module, configured to obtain a timing length from the timer when the communication module receives a ready signal from the transmitter, and further configured to substitute the timing length into the function to obtain a decryption key, and further configured to decrypt the electronic file using the decryption key.

8. The device according to claim 7, wherein the timing length is a time duration during the communication module starts to transmit the request signal until the communication module receives the ready signal.

9. The device according to claim 7, wherein the request signal comprises an IP address of the device and a desired electronic file.

10. The device according to claim 7, wherein the device is a personal computer.

11. A method for encrypting electronic files applied in a device, the device comprising a storage unit, a communication module, a timer, an obtaining module, and an encryption module, the storage unit storing the electronic files and a function, the method comprising:
receiving a request signal via the communication module, the request signal comprising an IP address of a receiver and information about a desired electronic file;
obtaining the function, and the electronic file from the storage unit via the obtaining module and starting to time via the timer;
obtaining a timing length via the encryption module when the electronic file has been obtained completely;
substituting the timing length into the function to obtain an encryption key via the encryption module;
encrypting the electronic file using the encryption key via the encryption module; and
transmitting the encrypted electronic file to the receiver according to the IP address of the receiver via the communication module.

12. A method for decrypting electronic files applied in a device, the device comprising a storage unit, a communication module, a timer, and a decryption module, the storage unit storing electronic files and a function, the method comprising:
transmitting a request signal via the communication module and starting to time via the timer;
obtaining a timing length from the timer via the decryption module when the communication module receives a ready signal;
obtaining the function from the storage unit via the decryption module;
substituting the timing length into the function to obtain a decryption key via the encryption module;
decrypting an electronic file received by the communication module using the decryption key via the decryption module.
